(19) United States
(12) Patent Application Publication
(10) Pub. No.: US 2002/0098933 A1
(43) Pub. Date: Jul. 25, 2002

(54) Bicycle chain tensioner and anti-wheel slip device

(76) Inventor: Scott Russell Kline, Paxinos, PA (US)

Correspondence Address: Scott Russell Kline, R R I, Box 330, Paxinos, PA, 17860, US

(21) Appl. No.: 09/768,755

(22) Filed: Jan. 25, 2001

(51) Int. Cl. F16H 7/08; F16H 7/14

(52) U.S. Cl. 474/116

(57) ABSTRACT

A washer with grooves matching the grooves of the dropout of a bicycle frame. The washer can slide a reasonable distance forward or backward in the grooves of the bicycle frame to enable proper chain tension and wheel alignment of the bicycle. When tightened the grooves would lock the wheel in place preventing undesired movment of the wheel.

### BACKGROUND OF THE INVENTION

1. Field of the Invention

The present invention relates in general to bicycles and in particular BMX bicycles.

2. Description of Related Art

A common problem among bicycle riders is that the rear wheel has a tendency to slip out of center causing the tire to rub the frame and brake malfunction to occur and this often results in a delay of riding until the wheel can be straightened. These difficulties can be overcome with the use of current chain tensioning devices which all feature some variation of a nut, bolt, and washer assembly. Some have even built the device into the frame of the bicycle. These traditional chain tensioners all have a tendency to come loose in a short amount of time. They tend to be cumbersome to use efficiently and they very often break or bend. Another common dilema is that while riding the nut on the chain tensioner in use will vibrate loose and be lost. Often a rider may be cut by the protruding bolt of the chain tentioner.

### SUMMARY OF THE INVENTION

The object of the present invention is to provide a chain tensioning device that is simpler in design with no moving parts, lighter in weight, easier to use, and lower in maintenance which utilizes more surface area than conventional smooth dropouts and washers resulting in better performance than previously existing chain tensioners.

These objects can be achieved by having grooves machined into the dropout of newly manufactured bicycle frames and installing a separate washer with identical grooves to those on the dropout of the bicycle frame so that the grooves can mesh together. On the grooved side of the washer a raised step that fits into the axle slot ensures that the grooves align correctly with each other. When the rear wheel is in place in the dropout of the bicycle the washer is placed onto the axle first with the grooves facing inward so that the grooves of the washer mesh with the grooves of the frame. The axle nut is then placed onto the axle and tightened just until the wheel can slide forward or backward without the grooves catching on each other. When the desired chain tension is found the wheel is held by the operator until the axle nut is turned a few times after which the grooves would fully mesh and lock together consequently holding the wheel in place. The same process is repeated on the other side of the frame making sure that the wheel is centered. Even though there is no chain to tension on this side of the frame the device will prevent the wheel from slipping out of alignment.

### BRIEF DESCRIPTION OF THE DRAWINGS

FIG. 1. is an enlarged side view of the bicycle frame dropout with grooves.

FIG. 2. is an enlarged side view of the grooved side of the washer.

FIG. 3. is an enlarged top view of the washer.

### DETAILED DESCRIPTION

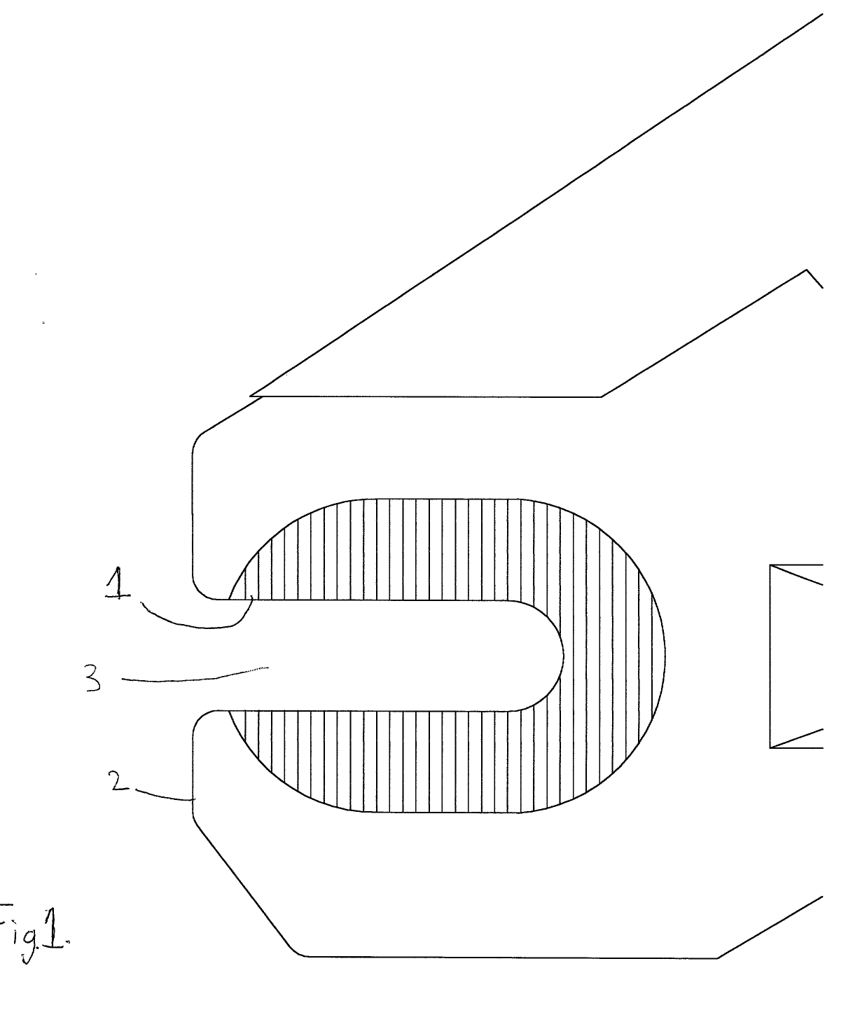

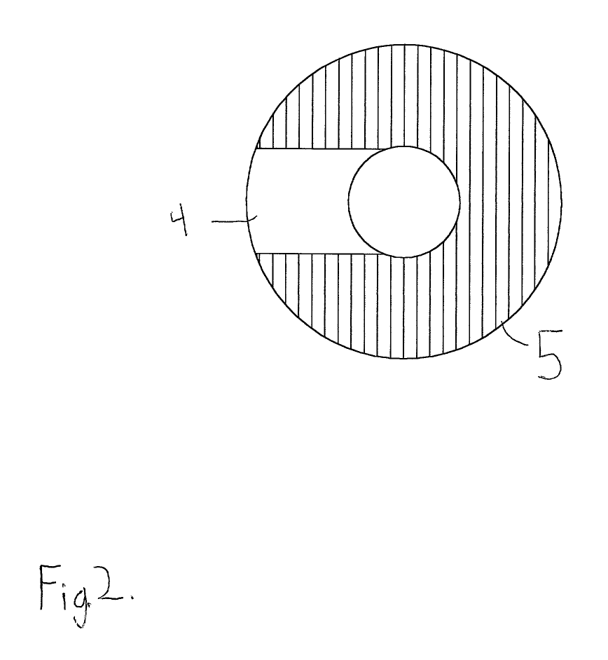

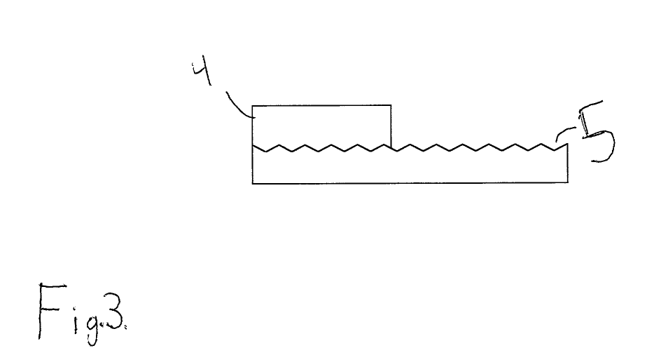

Refer now to FIG. 1. which shows the preferred embodiment of the present invention, comprising a set of grooves 1 on the dropout of the bicycle frame 2 conforming to the shape of the washer FIG. 2. with grooves 5. The grooves 1 of the dropout 2 providing a reasonable amount of travel for the neccessary adjustment of the position of the wheel and the tensioning of the chain. The dropout 2 and washer FIG. 2. are preferably manufactured of a strong metal. The grooves 1 are only on the outside of both dropouts 2. FIG. 3. shows the top view of the washer and grooves 5 and the raised step 4 of the washer that serves to align grooves 5 with grooves 1 when the step 4 is inserted into the axle slot 3. These grooves 1 and 5 also create a significant amount more surface area than conventionally smooth dropouts and washers, which subsequently makes a stronger connection between the wheel and the frame. The device is used by placing the washer FIG. 2. with the grooves 5 inward onto the axle first and before the axle nut. When the rear wheel has been placed in the axle slots 3 of the dropout 2 the axle nut is tightened just until the wheel can slide backward and forward without the grooves locking together. The wheel is then held in the proper position by the operator with the desired amount of tension on the chain at which time the axle nut is given a few turns thus engaging the grooves 5 of the washer with the grooves 1 of the dropout 2 and thereby keeping the tension on the chain by ensuring that the wheel will not slip out of alignment. The process is then repeated on the opposite side of the bicycle locking the wheel in a centered position. The dropout 2 and the washer FIG. 2 can be manufactured in many shapes and sizes to accomadate different needs according to the type of bicycle to which the present invention is applied. This is the preferred embodiment and use of this invention. This description is not exhaustive or intended to limit the invention to the form described. Several modifications and variations are possible in the light of the above teaching. It is intended that the scope of the invention be limited, not by the detailed description, but by the claims appended thereto.

I claim:

1. A bicycle chain tensioning and anti-wheel slip device comprising grooves which are present on the dropout of the bicycle frame and a washer; said grooves on said dropout providing a reasonable amount of adjustability whereby said grooves will increase the amount of surface area contact between the wheel and the bicycle frame; said washer also comprising a raised step that fits into the axle slot in the dropout of the bicycle frame for the purpose of aligning said grooves to the result that the tension of the chain of the bicycle is kept and the wheel is locked in place preventing undesired movement.
